(19) United States
(12) Patent Application Publication
(10) Pub. No.: US 2013/0174440 A1
(43) Pub. Date: Jul. 11, 2013

(54) METHOD OF SUPERCRITICAL POINT DRYING WITH STASIS MODE

(71) Applicant: Chris Tousimis, Cabin John, MD (US)

(72) Inventor: Chris Tousimis, Cabin John, MD (US)

(21) Appl. No.: 13/543,201

(22) Filed: Jul. 6, 2012

Related U.S. Application Data
(60) Provisional application No. 61/504,896, filed on Jul. 6, 2011.

(51) Int. Cl. F26B 1/00

(52) U.S. Cl. CPC F26B 1/00
USPC 34/381

(57) ABSTRACT

An improved method for supercritical point drying of a treated sample immersed in an intermediate drying fluid (e.g., ethanol or acetone), by purging the intermediary fluid with transitional fluid, and then entering a “stasis mode” allowing the sample to sit in its liquid state in the transitional fluid for a predetermined amount of time to extract any residual intermediary fluid into the transitional fluid. This ensures more thorough purging of the intermediary fluid from the sample and drying chamber, ultimately yielding a much higher success rate when drying thicker samples in the dryer.

### CROSS-REFERENCE TO RELATED APPLICATION(S)

The present application derives priority from U.S. provisional application Ser. No. 61/504,896 filed Jul. 6, 2011.

### BACKGROUND OF THE INVENTION

1. Field of the Invention

The present invention relates to improvements in critical point dryers for sample preparation for electron microscopy and semiconductor wafer manufacturing and, particularly, to a method for controlling a critical point drying apparatus using a computer system that employs a ‘stasis’ mode that effectively shuts down the apparatus and allows a sample to sit in a liquid state for a predetermined amount of time, so that any intermediary fluid in the sample can be fully purged.

2. Description of the Background

During conventional drying processes a sample in a liquid state will change phases from liquid to gas, resulting in a decrease to the liquid volume. This causes surface tension in the liquid which can destroy delicate structures. Thus, conventional drying is inappropriate for use on some microelectromechanical systems (MEMS) devices, biological samples, or other delicate structures.

This can be avoided by supercritical (or “critical point”) drying, which is a process to remove liquid in a precisely controlled way. It is commonly used in the production of microelectromechanical systems (MEMS), the production of aerogel, and in the preparation of biological specimens for scanning electron microscopy.

Prior to critical point drying, a dehydrating fluid such as ethanol or acetone gradually replaces the water contained in a specimen. This maintains the three-dimensional hydrated morphology of the structure under study.

Critical point drying devices for sample preparation in electron microscopy are known in the art. The prior art critical point dryers utilize the technique of substituting a transitional fluid for the dehydrating fluid in the cell structure and then removing the transitional fluid. A critical point dryer heats and pressurizes the biological specimen until above the critical pressure and critical temperature. The critical temperature is defined as the temperature above which a gas cannot be liquefied by pressure alone. The critical pressure is the pressure that results when a substance exists as a gas and a liquid in equilibrium at the critical temperature. The critical point of a liquid is when its temperature and pressure are at or above the critical temperature and pressure and the densities of the liquid phase and vapor phase are identical. This critical point is characterized by an absence of phase boundaries that normally exist between a liquid and its vapor at temperatures and pressures below the critical point. This absence of a phase boundary eliminates the boundary forces that exist when changing a liquid to a gas. These boundary forces are what cause the destruction of the extremely delicate specimens when changing its internal liquid to a gas below the critical point. Therefore, critical point drying processes remove the internal liquid from the sample (biological specimen, MEMS device, etc.) above its critical pressure and temperature to eliminate the boundary force destruction that would otherwise result.

Although all fluids have a characteristic critical point which should allow direct removal without the use of dehydrating or transitional fluids, the critical point temperature and pressure of water is 374.2 degrees C. and 218 atmospheres. Achieving these temperatures and pressures would cause severe damage to most samples and therefore a fluid having a lower critical temperature and pressure is normally substituted. Commonly, a dehydrating fluid is used that is miscible with water (e.g., ethanol or acetone) as an intermediate stage between the specimen containing water and a specimen containing transitional fluid.

Carbon dioxide (CO₂) is a common transitional fluid used in critical point dryers because it is easy to use, more economical, less noxious and provides consistently better results than other transitional fluids. The critical temperature and pressure of carbon dioxide is 31 degrees C. and 1,072 psi, respectively, thus reducing the potential for destruction of the specimen structure.

Typical apparatuses for critical point drying include a drying chamber that is connected to a supply of the transitional fluid with various regulating valves, temperature gauges and a means for heating the chamber. A skilled technician must carefully control the application, heating, pressurizing and removal of the transitional fluid, thus requiring not only time but also constant attention.

Applicant's U.S. Pat. No. 6,857,200 discloses a computer-controlled supercritical point drying apparatus for semiconductor device manufacturing and bio-medical sample processing in which a computer system automates the operational modes in drying the specimen. The disclosed operational modes controlled by the computer system are: cooling, in which a drying chamber is cooled; starting, in which the specimen chamber is filled with a transitional fluid; purging, in which the transitional fluid purges an intermediary fluid from the drying chamber (and optionally the purged intermediary fluid is collected by a collector condenser); heating, in which the drying chamber is heated to elevate the transitional fluid above its critical point temperature and pressure; and bleeding, in which the drying chamber is depressurized to atmospheric pressure at a very slow rate until the drying chamber is completely vented, which signals the end of the drying operation.

The general operation of a critical point dryer is disclosed in the '200 patent, and its FIG. 1 (reproduced herein) is a perspective view showing the external configuration of an exemplary critical point drying apparatus 1. The housing 24 encloses internal valves, wiring, piping, switches, relays and computer system components that make up the critical point drying apparatus 1. A power switch 22 applies electrical power to the dryer through a fuse. The operation indicator LEDs 16-21 indicate the individual operation that is being undertaken in the drying chamber 40, including: cool LED 16, fill LED 17, purge LED 18, heat LED 19, bleed LED 20 and vent LED 21. The temperature gauge 23 and the pressure gauge 69 provide visible indicators of the present conditions within the drying chamber 40. Transitional fluid and cooling fluid enter the critical point drying apparatus 1 through the inlet port 52. Exhausted cooling fluid exits the critical point drying apparatus 1 through the cool exit port 51. Purged dehydrating fluid and exhausted transitional fluid exits the critical point drying apparatus 1 through purge port 50.

FIG. 2 (reproduced FIG. 9 of the '200 patent) illustrates the various valves and connection lines for the routing of cooling fluid and transitional fluid through the critical point drying apparatus.

During cooling, the transitional fluid or a separate closed loop or electronic device is utilized to cool the drying chamber 40. If using transitional fluid, preferably liquid carbon dioxide, is provided at the inlet port 52 and then flows through a filter assembly 53 to the 3-way tee 54. When the computer system 99 energizes a cool valve 55 solenoid, the cool valve 55 supplies the transitional fluid through a metering valve to the drying chamber 40 at the cool inlet 41, wherein the transitional fluid is evaporated and ducted throughout the wall of the drying chamber 40. The warmed vaporized cooling fluid is ducted out of the critical point drying apparatus 1 at the cool port 51.

During starting, the drying chamber 40 is filled with transitional fluid. The computer system 99 energizes the fill valve 56, transitional fluid flows into the fill inlets 43, 44 to fill or purge the drying chamber 40. When the drying chamber 40 is being filled with the transitional fluid, the computer system 99 energizes the fill valve 56, and transitional fluid flows from the inlet 52 through tee 54 to fill valve 56, on through a check valve 57, a 4-way tee 58 and into the drying chamber 40 through the fill inlets 43, 44. The fill inlets 43, 44 are coupled to each other through 4-way tee 58 and 3-way tee 59. The in-line check valve 57 protects the fill valve from any backflow from the drying chamber.

During purging, the transitional fluid purges an intermediary fluid from the drying chamber and the purged intermediary fluid may be collected by a collector condenser. The computer system 99 commands the purge valve 63 to open. The intermediary fluid is forced from the drying chamber 40 through the purge outlets 45, 46 and into the connection line through a filter assembly 61, which is connected to the purge valve 63. The purged fluid exits the critical point drying apparatus 1 through the purge outlet 50. Throughout the entire purging process, the computer system 99 monitors the drying chamber temperature and keeps the drying chamber 40 below a predetermined temperature, preferably 5 degree. C or less. The cycle time for executing a purge of the intermediary fluid from the drying chamber 40 is controlled by the computer system 99.

After the purge cycle for the purging of the intermediary fluid is complete, the computer system 99 closes the purge valve 63 and can allow the fill valve 56 to continue filling the drying chamber 40 with transitional fluid. This ensures the transitional fluid fills the drying chamber 40 completely. The computer system 99 then advances the drying chamber 40 into the heating cycle.

During heating, the drying chamber is heated to elevate the transitional fluid to its critical point temperature and pressure. The computer system 99 activates the heater 32 to raise the transitional fluid to its critical point pressure and critical point temperature, thereby reaching critical point equilibrium. Preferably, the heater 32 raises the drying chamber temperature to at least 311 degree. C. or greater, which, in turn, causes the temperature and pressure of the transitional fluid to reach its critical point temperature and pressure.

A bleed valve 62 is provided for depressurizing/exhausting the drying chamber and a purge valve 63 is provided for purging the chamber with dry air, and the two are herein referred to separately for illustration although one skilled in the art will understand that a single valve may perform both functions of the bleed valve 62 and purge valve 63. After the computer system 99 has determined that the specimen has been at the critical point equilibrium for a sufficient amount of time, the computer system 99 keeps the heat on and commands the bleed valve 62 to open, thereby allowing the transitional fluid to exhaust out of the drying chamber 40 and exit the critical point drying apparatus 1 through the purge outlet 50. Bleeding entails depressurizing the drying chamber to atmospheric pressure at a very slow rate until the drying chamber is completely vented, which signals the end of the drying operation. When the transitional fluid is exhausted, it flows from the drying chamber 40 through a filter assembly 60 into the bleed valve 62 and then into the check valve 64.

When the drying chamber pressure is reduced to around 400 psi, the computer system 99 turns off the heater 32 and switches from bleed to vent mode. The computer system 99 commands the bleed valve 62 to close and the purge valve 63 to open. This returns the drying chamber to atmospheric pressure, which signals the end of the drying operation.

The entire disclosure of Applicant's U.S. Pat. No. 6,857,200 is herein incorporated by reference.

Although the computer-controlled critical point drying apparatus substantially eliminates the need for constant operator attention, it has been found that thicker samples such as aerogels, sogels, MOF's (metal organic ferameworks) and hydrogels are not fully purged of transitional fluid during the purge step, resulting in a tainted sample. For example, FIG. 3 illustrates the drying chamber 40 with a thicker sample placed in the chamber 40, the sample interior being saturated with an intermediary fluid such as ethanol or isopropyl alcohol (IPA), the jagged lines representing the intermediary fluid. During purging (described above), liquid carbon dioxide (LCO₂) is pumped into the chamber 40, and the intermediary fluid and LCO₂ exit through the purge outlet 50 of FIGS. 1-2. The problem with the thicker samples is that the intermediary fluid, though purged from chamber 40, may still remain inside of the sample. Thus, when the chamber 40 rises above the critical temperature and pressure, the sample structure will collapse due to the residual intermediary fluids still present inside of it, and an incomplete drying will occur. A more even and thorough purge of the intermediary fluid from the drying chamber 40, including all intermediary fluid inside of the sample, is absolutely necessary for successful supercritical point drying. A method of supercritical point drying is herein disclosed which includes a “stasis mode” that ensures a more thorough purge of the intermediary fluid from the sample and drying chamber, thereby allowing the operator to have a much higher success rate when drying thicker samples in the dryer.

### SUMMARY OF THE INVENTION

It is, therefore, an object of the invention to provide a method of supercritical point drying which includes a “stasis mode” for more thorough purging of the intermediary fluid from the sample and drying chamber, and ultimately a much higher success rate when drying thicker samples in the dryer.

In accordance with the foregoing object, the present invention provides an improved method for supercritical point drying of a treated sample (immersed in an intermediate drying fluid e.g., ethanol or acetone), comprising the steps of cooling a drying chamber to a predetermined temperature, placing the treated specimen in the drying chamber, filling the drying chamber with transitional fluid, purging the intermediary fluid by replacing it with the transitional fluid, entering a “stasis mode” allowing the sample to sit in its liquid state in the transitional fluid for a predetermined amount of time to extract any residual intermediary fluid into the transitional fluid. The stasis mode is essentially an extra phase added to the run cycle that allows the sample to sit in the chamber for selected amount of time, and/or to cycle through stasis mode for as many cycles as the operator deems necessary. Both the time in stasis mode and the amount of stasis mode cycles are fully programmable. At termination of the stasis mode the system checks to make sure the drying chamber temperature is cooled and another secondary purge is performed to remove more intermediary fluid. If desired, the system can be programmed to cycle through one or more additional stasis modes to thoroughly remove all intermediary fluid. Alternatively, the system will proceed to heat the drying chamber to elevate the transitional fluid to its critical point temperature and pressure, thereby reaching critical point equilibrium and maintaining it for a predetermined length of time, and then bleeding the drying chamber by depressurizing it to atmospheric pressure at a very slow rate until the drying chamber is completely vented.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 (prior art) is a perspective view of a computer-controlled supercritical point drying apparatus for semiconductor device manufacturing and bio-medical sample processing as set forth in U.S. Pat. No. 6,857,200.

FIG. 2 (prior art) is a perspective diagram of the computer-controlled supercritical point drying apparatus of FIG. 1.

FIG. 3 is a schematic illustration of a drying chamber with a thicker sample placed inside, both chamber and sample interior being saturated with an intermediary fluid.

FIG. 4 is a screen shot of the main menu of the present invention.

FIG. 5 is a block diagram of a method of supercritical point drying including a “stasis mode” according to the present invention.

FIG. 6 is a screen shot of the setup menu provided to the user after selecting the stasis mode icon 6 of FIG. 4.

FIG. 7 is a screen shot of the stasis setup menu provided to the user after selecting “Next” in the menu of FIG. 6.

### DETAILED DESCRIPTION OF THE PREFERRED EMBODIMENT

Reference will now be made in detail to preferred embodiments of the present invention, examples of which are illustrated in the accompanying drawings. Wherever possible, the same reference numbers will be used throughout the drawings to refer to the same or like parts.

The present invention is a method of supercritical point drying which includes a “stasis mode”, a specialized mode in which a state of inactivity is maintained for more thorough purging of the intermediary fluid from the sample and drying chamber, and ultimately a much higher success rate when drying thicker samples in the dryer.

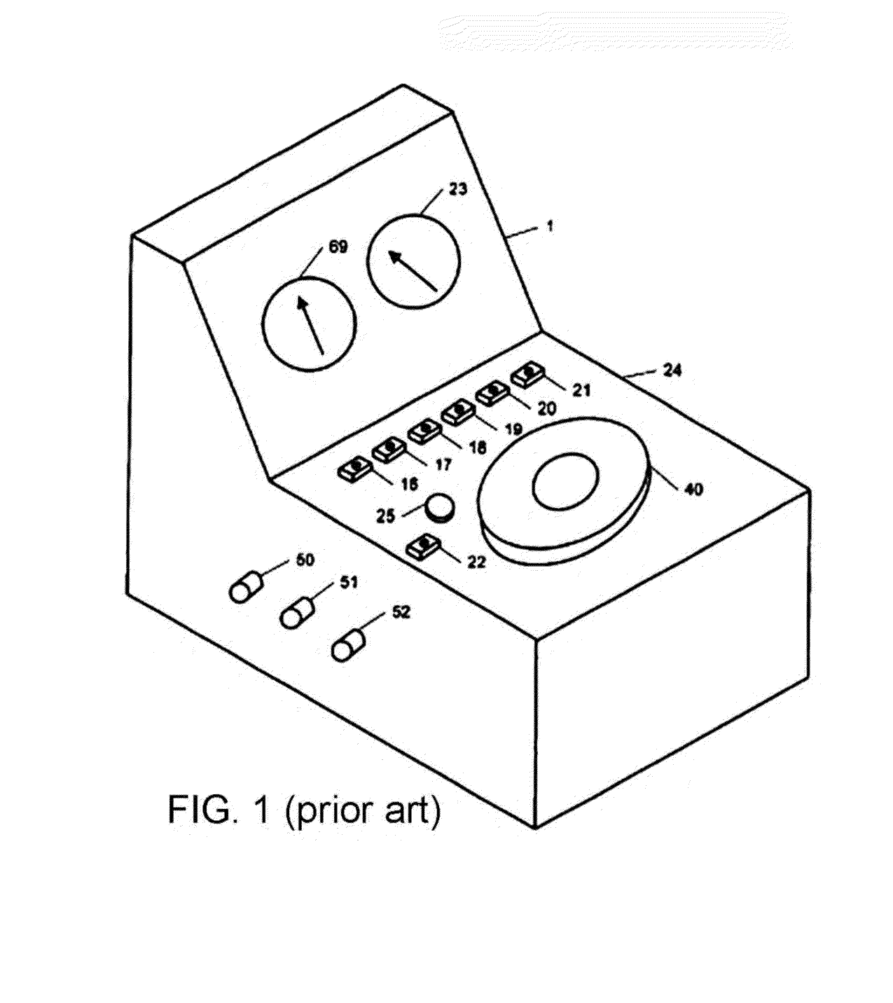

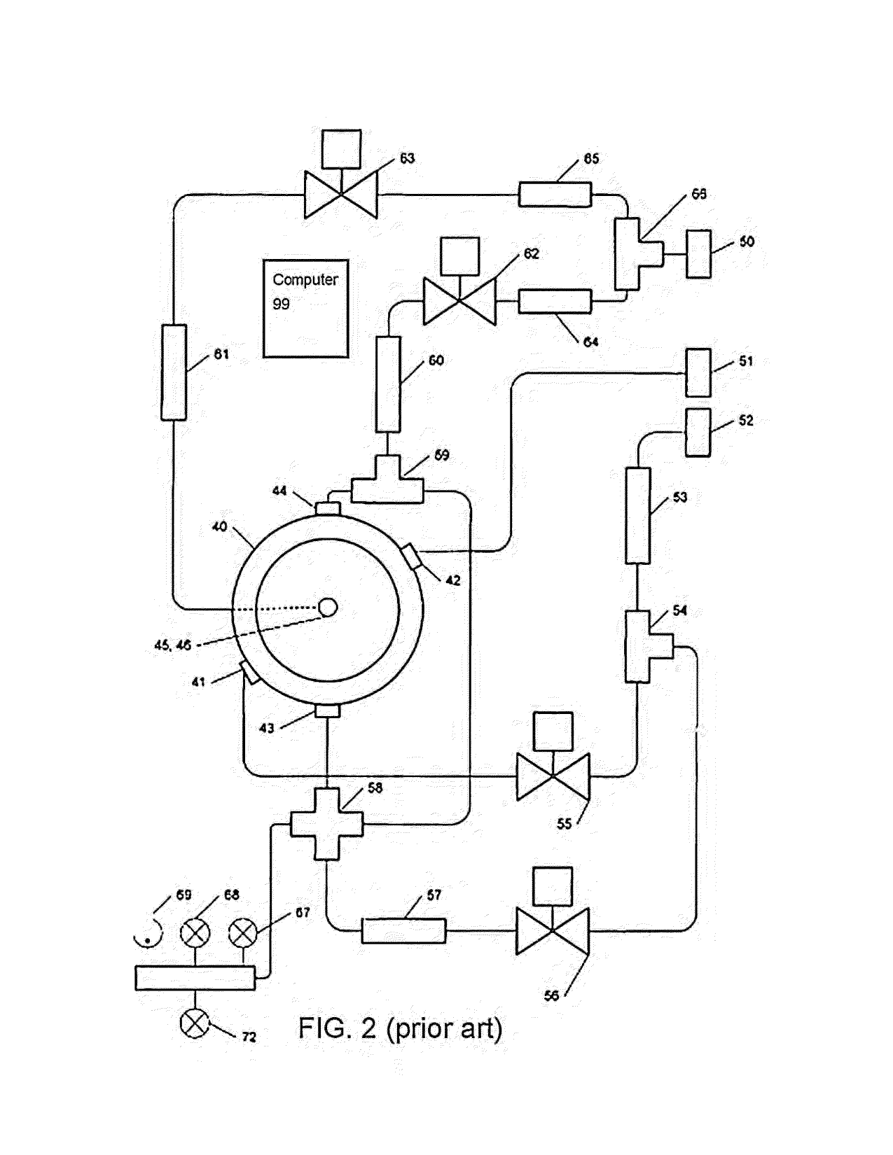

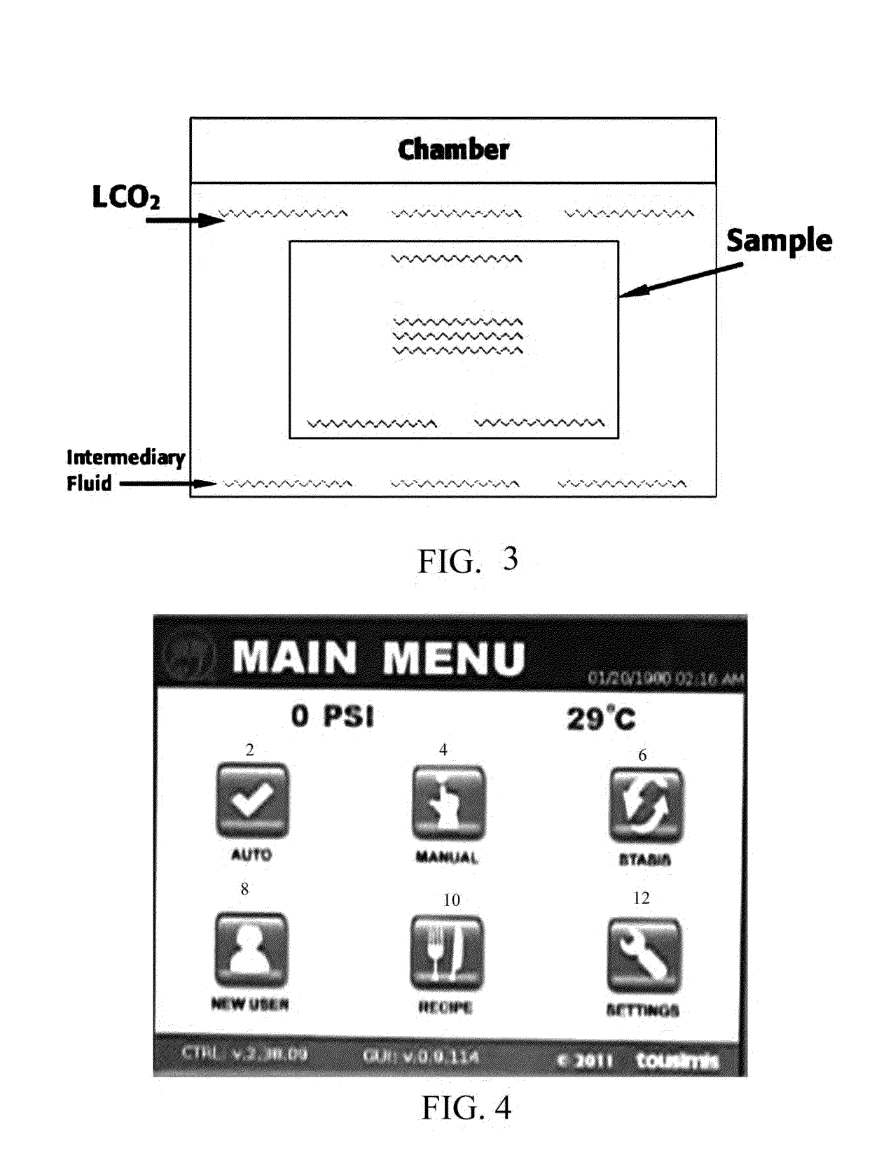

The present method may be implemented with a computer-controlled supercritical point drying apparatus as shown and described above with reference to FIGS. 1 and 2. As shown in FIG. 4, the computer system 99 includes a graphical user interface that allows the user to automatically complete the normal operational sequence for drying a sample in a dryer by pressing the Auto icon 2, or to manually (step-by-step) complete the operational sequence by pressing the Manual icon 4, or enter user information at icon 8, or customize any standard run parameters at Settings icon 12.

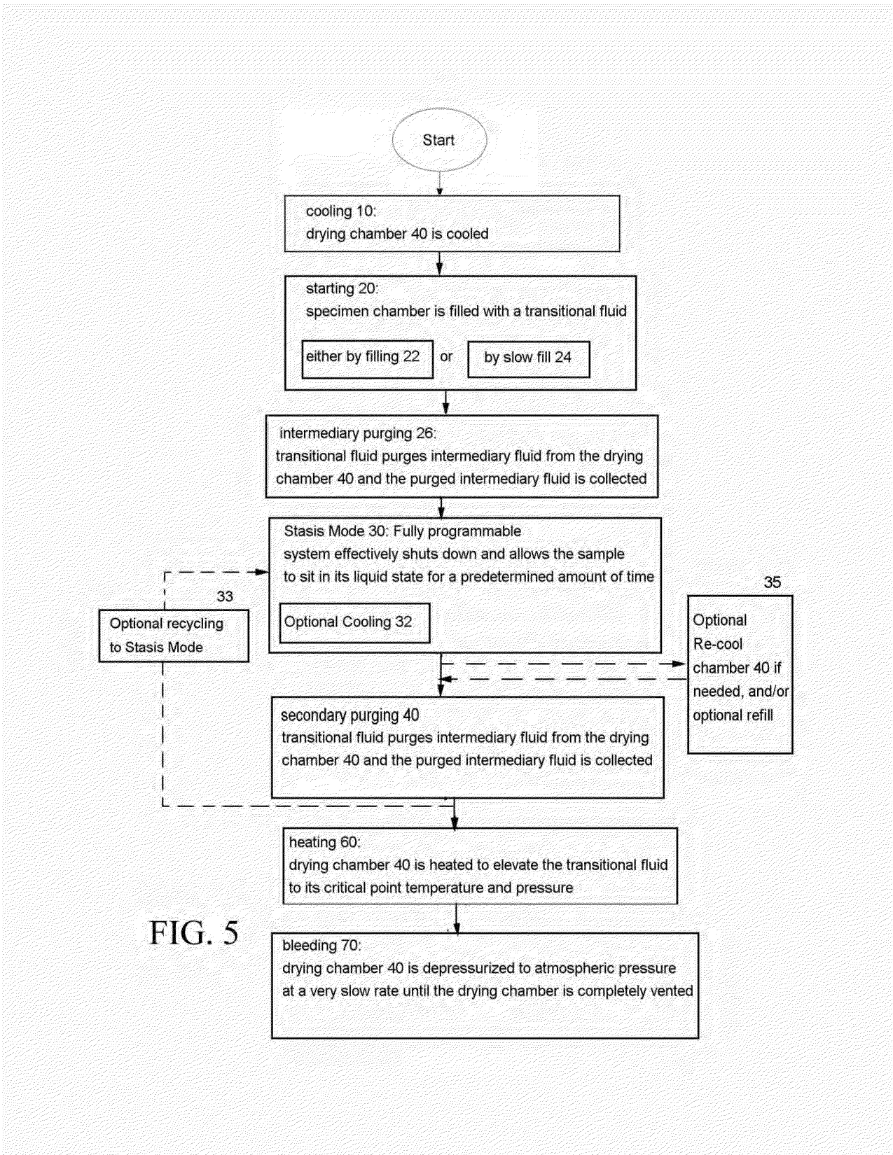

FIG. 5 is a block diagram of a method of supercritical point drying according to the present invention. The normal operational sequence for drying a sample in a dryer begins with the operator placing the sample inside the chamber in an intermediate fluid (e.g., ethanol or acetone). The chamber lid is then secured. The present method of supercritical point drying generally includes the following operational steps all controlled by the computer system 99 and user by the interface of FIG. 4, including: cooling 10 in which the drying chamber 40 is cooled; starting 20 in which the specimen chamber is filled with a transitional fluid either by filling at substep 22 or by slow fill at substep 24; first purging 26 in which the transitional fill flow is continued while the chamber is still cooled, and a vent valve is opened to allow the intermediary fluid to exit and be replaced by the LCO₂ (transitional fluid); Stasis Mode 30 (with or without optional cooling 32), in which the system effectively shuts down and allows the sample to sit in its liquid state for a predetermined amount of time. At termination of the stasis mode 30, at substep 32 the system checks to make sure the drying chamber temperature is cooled or if LCO₂ (transitional fluid) requires replenishment, and the chamber is then cooled or filled as needed.

Next, step 40 a secondary purge begins in which the transitional fluid is purged to remove any residual intermediary fluid.

At step 33, the system can optionally be programmed to cycle through one or more additional stasis modes 30, as desired, to thoroughly remove all intermediary fluid. After all stasis mode 30 and secondary purging cycles 40 are complete heating 60 occurs, in which the drying chamber 40 is heated to elevate the transitional fluid to its critical point temperature and pressure; and bleeding 70 in which the drying chamber 40 is depressurized to atmospheric pressure at a very slow rate until the drying chamber is completely vented, which signals the end of the drying operation.

Cooling 10

The first step in the critical point drying operation is to cool the drying chamber 40 to a temperature that will condense the transitional fluid to be added later. Preferably, the cooling fluid is liquid carbon dioxide (LCO₂). In the context of FIGS. 1-2, the transitional fluid LCO₂, is used, and is provided at the inlet port 52 and then flows through a filter assembly 53 to the 3-way tee 54. The computer system 99 energizes a cool valve 55 solenoid, the cool valve 55 supplies the transitional fluid through a metering valve to the drying chamber 40 at the cool inlet 41. The transitional fluid is evaporated and ducted throughout the wall of the drying chamber 40. The chamber 40 temperature is lowered to a predetermined setting so that the LCO₂ can be filled in a liquid state. Cooling can also take place via a closed loop system or electronic device attached to the chamber wall to remove heat.

Starting 20

Typically, the specimen will have been previously dehydrated with dehydrating fluid such as ethanol, methanol or acetone. The treated specimen is placed in the drying chamber 40 along with an amount of the dehydrating fluid. After the treated specimen has been placed in the drying chamber 40 and the cover secured, the specimen chamber 40 is filled with transitional fluid. The computer system 99 energizes the fill valve 56, transitional fluid flows into the fill inlets 43, 44 to fill the drying chamber 40. When the drying chamber 40 is being filled with the transitional fluid, the computer system 99 energizes the fill valve 56, and transitional fluid flows from the fill valve 56, through a check valve 57, a 4-way tee 58 and into the drying chamber 40 through the fill inlets 43,44. The fill inlets 43, 44 are coupled to each other through 4-way tee 58 and 3-way tee 59. The in-line check valve 57 protects the fill valve from any backflow to the drying chamber filling at substep 22. The specimen chamber 40 may be filled with the transitional fluid either by or by slow fill at substep 24. With slow fill 24 the pressure of the chamber 40 is built up at a slower rate so that the specimens will not be injured by a rapid flush of transitional fluid into the chamber 40. Filling at substep 22 occurs at a normal rate, and in both cases the chamber 40 remains cooled from cooling step 10.

First (“Intermediary”) Purge 26

During intermediary purge 26, the fill flow is continued and the vent valve is opened while the chamber is still cooled. The purge step 26 purges the intermediary fluid and replaces it with the LCO₂ (transitional fluid). When the intermediary fluid is to be purged from the drying chamber 40, the computer system 99 commands the purge valve 63 to open. The intermediary fluid is forced from the drying chamber 40 through the purge outlets 45, 46 and into the connection line through an optional filter assembly 61, which is connected to the purge valve 63. The purge valve 63 may be heated to prevent the purge valve 63 from freezing when the transitional fluid or the intermediary fluid passes through the purge valve 63. The purge valve 63 also includes a metering valve to control the flow rate at which the intermediary fluid is purged. An optional check valve 65 prevents fluid backflow through the purge valve 63 into the drying chamber 40. The optional check valve 65 is connected to the purge outlet 50 by 3-way tee 66. The purged fluid exits the critical point drying apparatus 1 through the purge outlet 50. Throughout the entire intermediary purging process, the computer system 99 monitors the drying chamber temperature and keeps the drying chamber 40 below a predetermined temperature, preferably 5 degrees C. or less. The cycle time for executing a purge of the intermediary fluid from the drying chamber 40 is controlled by the computer system 99. Preferably, the purge time is adjusted by a purge timing control 25 that is located on the housing 24 of the critical point drying apparatus 1. After the purge cycle for the purging of the intermediary fluid is complete, the computer system 99 closes the purge valve 63 and allows the fill valve 56 to continue filling the drying chamber 40 with transitional fluid. This ensures the transitional fluid fills the drying chamber 40 completely.

Stasis Mode 30 (With or Without Optional Cooling 32)

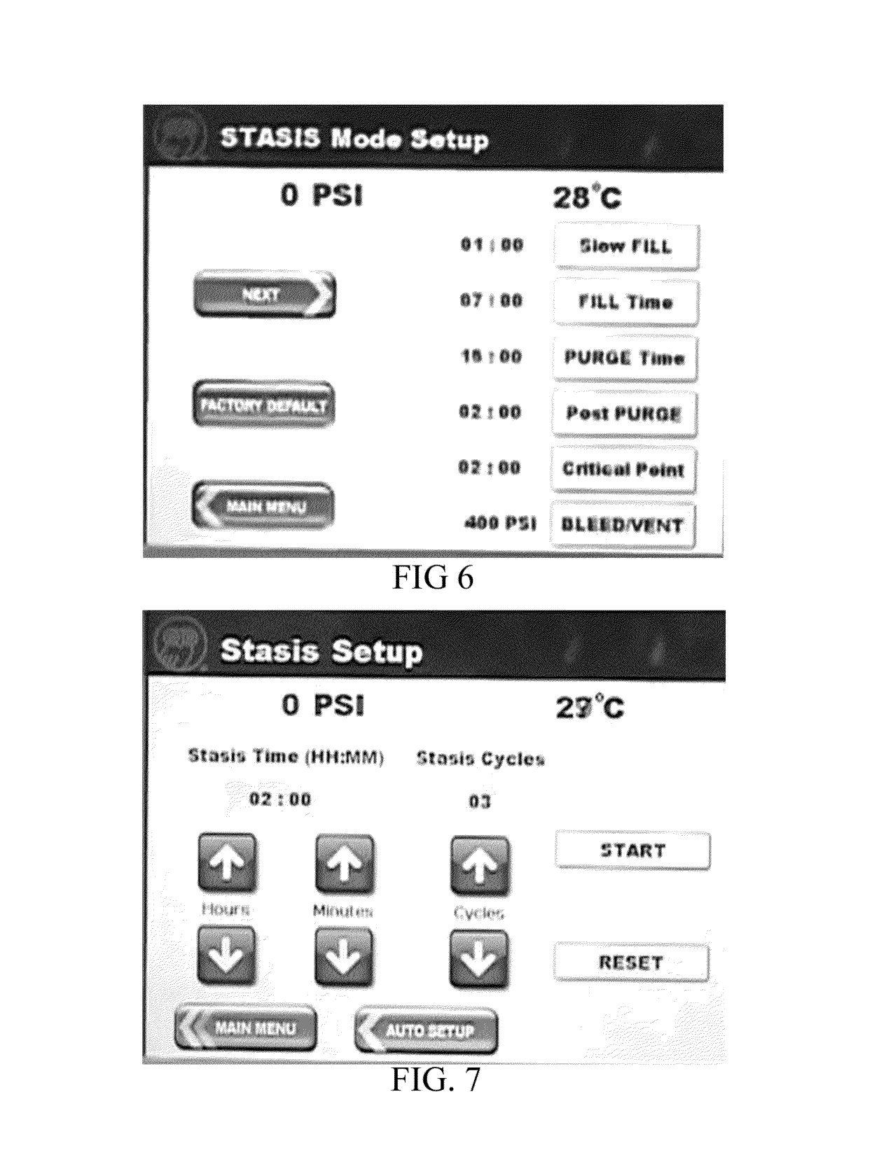

If the operator has a difficult sample that will need the stasis mode, it can be selected from the user interface of FIG. 4 by selecting the stasis mode icon 6. This allows the user to interject stasis mode into the automated process at the outset or, alternatively, enter stasis mode directly in the midst of a process. When the user selects the stasis mode icon 6 he is initially presented with a setup menu as shown in FIG. 6. The setup menu allows the user to customize any standard run parameters or just choose to enter the stasis programming directly (by pressing “Next”). Standard run parameters include slow fill time (described above with reference to FIG. 5 at substep 24), fill time as at substep 22, first (or intermediary) purging time as at substep 26, secondary purge time as at step 40, critical point heating time as at step 60, and bleed/vent pressure (psi) as at step 70. By pressing “Next” the time in stasis can be selected followed by the amount of times to cycle through the stasis mode 30. Pressing “Next” engenders the stasis setup menu shown in FIG. 7. The user is presented with Up/Down arrows for each of hours, minutes and cycles, allowing hours and minutes in stasis to be selected as well as the number of times to cycle through the stasis mode 30. Given desired selections, the fully automatic process can be initiated by pressing “Start.” The system will cool, fill and enter purge as described above, then enter the stasis mode 30. During Stasis Mode 30 the computer system 99 closes all valves and vents, effectively shutting the system 1 down and allowing the sample to sit in its liquid state for a predetermined amount of time. The sample resides in the chamber in a liquid state, and may then warm up to room temperature. This may allow for lower liquid densities making it easier for any intermediary fluid that may possibly remaining inside the sample to have that predetermined amount of time to flow out and join the other transitional fluid in the chamber 40. During stasis mode the drying chamber contents goes from a cool state that it is normally in a range of about −5 C to 10 C, to a warmed state, warming up to room temperature (around 24 C). When this occurs the liquids remain in a liquid phase but densities and viscosities of the liquid decrease (as temperature warms density decreases along with viscosity and resistance to flow), resulting in easier fluid diffusion through the sample. This provides any intermediary fluid in the sample with more favorable conditions to exit the sample and to be purged out of the drying chamber later. Again, the length of the “stasis” mode is preprogrammed by the operator and, if desired, the system can be programmed to cycle through the Stasis mode 30 more than once. At the end of stasis mode the system 1 will reactivate. Cooling 32 may optionally take place during Stasis mode 30. Moreover, if desired, at optional step 35 re-cooling and/or LCO₂ (transitional fluid) replenishment may optionally take place after Stasis mode 30. For example at termination of the stasis mode 30, at substep 35 the system may check to ensure that the drying chamber temperature is cooled or if LCO₂ (transitional fluid) requires replenishment, and the chamber is then cooled or filled as needed. Cooling can be accomplished by adiabatic cooling with the LCO₂. However, one skilled in the art will understand that the drying chamber can be cooled by any of several techniques, not just the adiabatic cooling with the LCO2. For example, a closed loop cooling system can be connected to the drying chamber such as a thermoelectronic (Peltier) cooling device or any other suitable cooling system.

In an aspect of the invention, the critical point drying apparatus may cycle through another filling of the drying chamber 40 with the transitional fluid to ensure that the transitional fluid completely fills the drying chamber 40.

After the stasis mode 30 and prior to a secondary purge 40 described below, at substep 32 the system checks to make sure the drying chamber temperature is cooled. If re-cooling is needed or if LCO₂ (transitional fluid) requires replenishment, then at optional step 35 re-cooling and/or LCO₂ (transitional fluid) replenishment may take place, and the chamber is then cooled or filled as needed.

Secondary Purging 40

After any necessary cooling or replenishment at substep 32, secondary purging occurs. During the secondary purging 40 the transitional fluid is purged out. Just as in the first purge 26, the computer system 99 commands the purge valve 63 to open. The intermediary fluid is forced from the drying chamber 40 through the purge outlets 45, 46 and into the connection line through a filter assembly 61, which is connected to the purge valve 63. The purge valve 63 may be heated to prevent the purge valve 63 from freezing when the transitional fluid or the intermediary fluid passes through the purge valve 63. The purge valve 63 also includes a metering valve to control the flow rate at which the transitional fluid or intermediary fluid is purged. The drying chamber temperature is also maintained at a cool temperature during this phase.

At the end of the secondary purge 40, at step 33, the system can be selectively programmed, as desired, to cycle through one or more additional stasis modes, as desired, to thoroughly remove all intermediary fluid. Alternatively, the system proceeds to the heating phase.

Heating 60

During heating 60 the drying chamber 40 is heated to elevate the transitional fluid to its critical point temperature and pressure, thereby reaching critical point equilibrium. The computer system 99 activates the heater 32 to raise the transitional fluid to its critical point pressure and critical point temperature, thereby reaching critical point equilibrium. Preferably, the heater 32 raises the drying chamber temperature to at least 31.1 degrees C. or greater, which, in turn, causes the temperature and pressure of the transitional fluid to reach its critical point temperature and pressure. Once critical point equilibrium is reached, the equilibrium is maintained for a certain length of time.

Bleeding 70

After the computer system 99 has determined that the specimen has been at the critical point equilibrium for a sufficient amount of time, the chamber 40 is bled. During bleeding 70 the drying chamber 40 is depressurized to atmospheric pressure at a very slow rate until the drying chamber is completely vented, which signals the end of the drying operation. The computer system 99 commands the bleed valve 62 to open, thereby allowing the transitional fluid to exhaust out of the drying chamber 40 and exit the critical point drying apparatus 1 through the purge outlet 50. When the transitional fluid is exhausted, it flows from the drying chamber 40 through a filter assembly 60 into the bleed valve 62 and then into the check valve 64. The check valve 64 prevents backflow from backing through the bleed valve 62 into the drying chamber 40. The optional check valve 64 is connected to the purge outlet 50 through 3-way tee 66. The bleed valve 62 also comprises a metering valve to control the bleed rate. Preferably, the metering valve allows the system pressure to decrease at a rate of 100 psi/minute. This bleed rate prevents the transitional fluid from recondensing. In addition, the bleed valve 62 can be thermostatically heated to prevent the bleed valve 62 from freezing as the transitional fluid flows through it. During the bleed process, the computer system 99 maintains the drying chamber temperature at 31 degrees C. or above. This temperature level prevents recondensation on the specimen. When the drying chamber pressure is reduced to around 400 psi, the computer system 99 turns off the heater 32 commands the bleed valve 62 to close and the purge valve 63 to open, and vents the chamber 40. This returns the drying chamber 40 to atmospheric pressure quicker.

As noted above, one skilled in the art will understand that a single valve may perform both functions of the bleed valve 62 and purge valve 63.

Upon completion of the process, the sample can be removed from the chamber. What was a saturated wet sample, has now successfully dried with its structural integrity intact.

It should now be apparent that the above-described invention provides more efficient and effective methods of supercritical point drying using “stasis mode” for more thorough purging of the intermediary fluid from the sample and drying chamber, by allowing the sample to sit in the transitional fluid for longer periods of time and allowing for the fluids to raise to room temperatures making them higher density and with their higher diffusive qualities thus ultimately yielding a much higher success rate when drying thicker samples in the dryer.

Those skilled in the art will understand that various modifications and variations can be made in the present invention without departing from the spirit or scope of the invention. It is to be understood, therefore, that the invention may be practiced otherwise than as specifically set forth in the appended claims.

What is claimed is:

1. A method for supercritical point drying of a sample immersed in an intermediate drying fluid in a drying chamber, comprising the steps of:
cooling said drying chamber to a predetermined temperature;
placing the treated specimen in the drying chamber;
filling the drying chamber with transitional fluid;
purging the intermediary fluid by replacing it with the transitional fluid;
entering a stasis mode allowing the sample to sit in its liquid state in the transitional fluid for a predetermined amount of time to extract any residual intermediary fluid into the transitional fluid;
purging the intermediary fluid;
selectively repeating stasis mode;
heating the drying chamber to elevate the transitional fluid to its critical point temperature and pressure;
bleeding the drying chamber by depressurizing it to atmospheric pressure at a predetermined rate until the drying chamber is completely vented.

2. The method for supercritical point drying of a sample according to claim 1, wherein said step of entering a stasis mode allows the sample to sit in its liquid state in the transitional fluid for an amount of time programmed by a user.

3. The method for supercritical point drying of a sample according to claim 1, further comprising a step of repeating said stasis mode.

4. The method for supercritical point drying of a sample according to claim 3, wherein said step of repeating said stasis mode further comprises a step of repeating said stasis mode a predetermined number of cycles.

5. The method for supercritical point drying of a sample according to claim 3, wherein said step of repeating said stasis mode further comprises a step of repeating said stasis mode comprises allowing said user to select said predetermined number of cycles.

6. The method for supercritical point drying of a sample according to claim 1, further comprising cooling said sample during said stasis mode while said sample sits in its liquid state.

7. An automated method for supercritical point drying of a sample immersed in an intermediate drying fluid in a drying chamber, comprising:
a first step of providing a user-interface for allowing a user to preselect an amount of time within which to fill the drying chamber with transitional fluid, a first amount of time within which to purge the intermediary fluid from said drying chamber by replacing it with transitional fluid, an amount of time to remain in a stasis mode in which the sample sits in its liquid state in the transitional fluid for a predetermined amount of time to extract any residual intermediary fluid into the transitional fluid, and a second amount of time within which to purge the intermediary fluid from said drying chamber by replacing it with transitional fluid;
a second step of automatically cooling said drying chamber to a predetermined temperature;
a third step of automatically filling the drying chamber with transitional fluid for said preselected amount of fill time;
a fourth step of automatically purging the intermediary fluid for said first preselected amount of purge time by replacing it with the transitional fluid;
a fifth step of entering said stasis mode and allowing the sample to sit in its liquid state in the transitional fluid for said predetermined amount of stasis time to extract any residual intermediary fluid into the transitional fluid; and
a sixth step of automatically purging the intermediary fluid for said second preselected amount of purge time by replacing it with the transitional fluid.

8. The automated method for supercritical point drying of a sample according to claim 7, further comprising a seventh step of automatically heating the drying chamber to elevate the transitional fluid to its critical point temperature and pressure

9. The automated method for supercritical point drying of a sample according to claim 8, further comprising an eighth step of automatically bleeding the drying chamber by depressurizing it to atmospheric pressure at a predetermined rate until the drying chamber is completely vented.

10. The automated method for supercritical point drying of a sample according to claim 7, wherein said fifth step of entering said stasis mode is automatic.

11. The automated method for supercritical point drying of a sample according to claim 7, wherein said fifth step of entering said stasis mode is manual.

12. The automated method for supercritical point drying of a sample according to claim 7, wherein said first step of providing a user-interface allows said user to preselect an amount of time to remain in a stasis mode, and a number of cycles to repeat said stasis mode.

13. The automated method for supercritical point drying of a sample according to claim 7, wherein said fifth step of said stasis mode further comprises cooling said sample during said stasis mode while said sample sits in its liquid state.

14. In a critical point drying apparatus for drying specimens including a drying chamber, a first valve for supplying a transitional fluid to the drying chamber, a second valve for purging intermediary fluid from said drying chamber, a heater for heating said drying chamber, and a computer system for operating the first valve, second valve, and heater, software comprising computer instructions stored on non-transitory memory for carrying out the following steps:
providing a user-interface for allowing a user to preselect an amount of fill time within which to fill the drying chamber with transitional fluid, an amount of purge time within which to purge the intermediary fluid from said drying chamber by replacing it with transitional fluid, an amount of stasis time in which the sample sits in its liquid state in the transitional fluid;
cooling said drying chamber to a predetermined temperature;
filling the drying chamber with transitional fluid for said preselected amount of fill time;
purging the intermediary fluid for said first preselected amount of purge time;
allowing the sample to sit in a liquid state in the transitional fluid for said predetermined amount of stasis time to extract any residual intermediary fluid into the transitional fluid.

15. The computer system according to claim 14, wherein said software comprises computer instructions stored on non-transitory memory for carrying out the additional step of heating the drying chamber to elevate the transitional fluid to its critical point temperature and pressure.

16. The computer system according to claim 15, wherein said software comprises computer instructions stored on non-transitory memory for carrying out the additional step of bleeding the drying chamber by depressurizing it to atmospheric pressure at a predetermined rate until the drying chamber is completely vented.

17. The computer system according to claim 14, wherein said step of providing a user-interface for allowing a user to preselect an amount of fill time further comprises providing a user-interface for allowing said user to preselect a number of stasis mode cycles to repeat said stasis mode.

18. The computer system according to claim 17, wherein said step of allowing the sample to sit in a liquid state in the transitional fluid for said predetermined amount of stasis time further comprises cooling said chamber during extraction of any residual intermediary fluid into the transitional fluid.
